(19) United States
(12) Patent Application Publication
(10) Pub. No.: US 2007/0238839 A1
(43) Pub. Date: Oct. 11, 2007

(54) Rotary Vertical Fluidized Bed Catalytic Poymerization Method

(76) Inventor: Axel de Broqueville, Grez-Doiceau (BE)

Correspondence Address: FINA TECHNOLOGY INC, PO BOX 674412, HOUSTON, TX, 77267-4412, US

(21) Appl. No.: 11/578,617

(22) PCT Filed: Mar. 24, 2005
(86) PCT No.: PCT/BE05/00039

§ 371 Date: Oct. 16, 2006

(30) Foreign Application Priority Data
Apr. 14, 2004 (BE) 2004/0186

(51) Int. Cl. B01J 8/18; B01J 8/38; C08F 2/00

(52) U.S. Cl. 526/59; 422/105; 526/68

(57) ABSTRACT

Method of catalytic polymerization in a fluidized bed, in which the reactive fluids are injected tangentially via openings (7) distributed along the side wall (3) of a cylindrical reactor (2) and removed via openings (9) distributed along a central stack (8) in order to rotate the polymer particles sufficiently fast so that, thrust by the centrifugal force toward a succession of fixed helical turns (13) running along the reactor wall, they can rise along their walls and fall back along their edges without entering the central stack.

The present invention relates to catalytic polymerization in a fluidized bed, rotating in a cylindrical reactor thanks to the tangential injection of gaseous or liquid reactive fluids, from the side wall of the reactor or from internal galleries running along this wall, toward a central stack passing through the reactor from one end to the other, around its axis of symmetry, and provided with uniformly distributed openings through which these fluids are removed.

The polymerization of a mixture of gaseous or liquid reactive fluids, containing the monomer or monomers to be polymerized, in a fluidized bed reactor, in which the polymer particles formed in the presence of a catalyst system are maintained in the fluid state, without the use of stirrers, by the upward movement of the mixture of reactive fluids, is well known. When this mixture of reactive fluids is separated from the particles before leaving the reactor, thereby bounding a generally horizontal separation surface, this mixture of reactive fluids escapes via the top of the reactor, generally in gaseous form, to be generally recycled to the bottom of the reactor, in liquid or gaseous form, after appropriate treatment in recycling devices.

In the present invention, mixtures of reactive fluids are moved by rotation in the horizontal sections of a vertical cylindrical reactor, from its side wall, where they are injected, approximately horizontally and tangentially to this wall, toward openings in a central stack, which may comprise a plurality of removal tubes for separately removing the various mixtures of reactive fluids passing through the various reactor sections toward independent purification and recycle devices in order to maintain different compositions and/or temperatures of these mixtures of reactive fluids in these various sections or zones of the reactor.

In the present invention, the vertical reactor contains, from one end to the other, a succession of fixed helical turns, surrounding the central stack at a certain distance therefrom and fixed to or at a short distance from the side wall of the reactor, for upwardly entraining the polymer particles which, driven by the rotation of the mixture of reactive fluids, rotate between the walls of the helical turns. The polymer particles then fall back by gravity into the free space on each side of these walls.

The polymer particles, which are confined by the centrifugal force and the helical turns in the vertical fluidized bed, located between the cylindrical side wall of the reactor and an approximately cylindrical separation surface, located between the succession of helical turns and the central stack, thereby rise between the walls of the helical turns and fall back on each side of these walls, following helical trajectories, thereby passing through the various zones of the reactor several times before being removed therefrom, and thereby giving them a uniform bi- or multimodal composition.

The reactor may be horizontal, if the force of gravity is replaced by a second succession of fixed helical turns, concentric to the first and oriented in the opposite direction. The polymer particles thereby travel from right to left under the influence of one succession of helical turns and from left to right under the influence of the other. The speed of rotation of the particles must be sufficient for the centrifugal force to be substantially greater than the gravitational force.

In the present invention, the centrifugal force is suitable for making the mixtures of reactive fluids pass through the fluidized bed at higher speeds than those permitted in fluidized beds based on the force of gravity alone, or for using fluids with a density closer to that of the polymer particles, and the approximately cylindrical shape of the fluidized bed is suitable for obtaining a ratio of its area to its thickness higher by one order of magnitude than the ratios obtained in conventional fluidized beds. This serves to obtain short residence times of the reactor fluids in the fluidized bed and thereby obtain high cooling capacities and good temperature control of the polymer particles. This makes it possible to use highly active catalyst systems and mixtures of concentrated reactive fluids, so that high polymerization rates can be obtained with relatively short polymer particle residence times in the reactor.

FIG. 1 shows the projection of a half-section of a vertical cylindrical reactor, serving to polymerize, in the presence of a catalyst system, particles in suspension in a mixture of liquid or gaseous reactive fluids. The figure shows the cross section of its side wall (2) and its cylindrical axis of symmetry (1).

A device for injecting mixtures of reactive fluids into the reactor is illustrated by a cylinder of cross section (3), running at a short distance along the side surface of the reactor, and which is perforated with numerous holes (4). The space between this cylinder and the reactor wall is divided into several sections by annular partitions (5) and is fed with mixtures of pressurized reactive fluids via inlet tubes (6). These mixtures of reactive fluids are injected into the reactor approximately horizontally and tangentially to its wall via numerous injection tubes passing through the holes of this perforated cylinder, whereof the outlets (7) can be seen, issuing from the surface of this cylinder in the background. Injection takes place in the direction of the arrows, that is from left to right.

A device for removing mixtures of reactive fluids is illustrated by a central nozzle (8), passing through the reactor from the top to the bottom, around its axis of symmetry (1), and comprising numerous openings (9), uniformly distributed along its surface and profiled in order to facilitate the entry of the fluids rapidly rotating in the reactor and to guide them toward its outlets. The central nozzle is divided by partitions whereof the cross sections (10) can be seen, bounding independent zones, connected to the exterior by the main outlet tubes (8.1) and (8.2) and an inner outlet tube (11). These tubes are connected to cooling, purification and/or separation devices (12), from which the fluids are recycled via inlet tubes (6) which feed the reactor zones located at more or less the same level as the zones of the central nozzle from which these recycled fluids issue. In this way, the fluids move inside approximately horizontal sections of the reactor, thereby limiting their mixing between the various zones.

A succession of helical turns (13), shown in full and fixed to the reactor (2) by fasteners, not shown in the figure, passes through the reactor from the top downward, in the cylindrical space between the perforated cylinder (3) and the central nozzle (8), so that the fluids, which rotate rapidly in the upward direction of the turns, entrain the polymer particles located in the helical space between the walls of the helical turns, called the upflow helical channel toward the top of the reactor.

The centrifugal force thrusts the particles toward the wall of the perforated cylinder. A free cylindrical space, called the free side space, which is relatively thin, between the succession of helical turns and the perforated cylinder, enables the polymer particles, which have risen in the upflow helical channel, to fall back by gravity and under the effect of the centrifugal force, into the bottom of the reactor.

If the speed of rotation and hence the upward flow rate of the particles in the upflow helical channel is sufficient, this thin space is insufficient to enable all the particles to fall back therein. In this case, the particles in suspension in the fluids will accumulate in the upflow helical channel until the surface of the fluidized bed reaches the free cylindrical space, called the free central space, which is relatively wide, located between the central nozzle and the set of helical turns, enabling the rest of the particles to fall back into the bottom of the reactor and enabling the fluids which, having rotated in the upflow channel, have risen lightly therein, to fall back to the level of the zone of the central nozzle which approximately corresponds to the inlet which they have used.

The helical turns are characterized by their width (14) and hence also that of the upflow helical channel, the widths (15) and (16) of the free central and side space, their pitch (17) and the height (18) between one another and which is also the height of the upflow channel. If the pitch of the helical turns (17) is equal to the distance (18) between them, the succession of turns can form a continuous fixed helical curve.

In FIG. 1, the pitch of the helical turns (17) is smaller than the height (18) of the upflow channel. The polymer particles must make on average a number of turns that is equal to the ratio of the height of the upflow channel to the pitch of the turns before passing from one turn to the upper turn. The turn pitch may also be larger than the height of the upflow channel and the dimensions of the turns may vary from one turn to another. A turn can be replaced without removing the others, by rotating it up to the top of the reactor.

One or more feed devices (19) are used to introduce the polymerization catalyst or catalyst system into the reactor and one or more openings (20) in the bottom or anywhere along the reactor can be used to remove the polymer particles in suspension in the fluids.

The free central space must be sufficiently wide and the injection speed of the fluids into the reactor must be sufficient to rotate the fluids and particles entrained by the fluids at a sufficiently high speed of rotation for the centrifugal force to produce a clear separation between the particles and the fluids before the latter enter the central nozzle, thereby forming a fluidized bed whereof the separation surface is located in the free central space, between the central nozzle and the set of helical turns. Its approximately cylindrical shape is distorted by helical corrugations due to the falling of the polymer particles along the inner edge of the turns, under the combined action of the force of gravity and the centrifugal force. The particles thereby follow upward helical trajectories in the upflow helical channel and downward trajectories in the free central and side space.

If the quality of polymer particles in suspension of the fluid increases, the separation surface of the fluidized bed approaches the central nozzle and risks entraining the particles therein. To prevent this, polymer particle detectors (21) serve to adjust the outgoing flow rate of particles in suspension in the fluids, in order to maintain the fluidized bed surface at a sufficient distance from the central nozzle.

This overall device is suitable for installing several separate circuits for recycling fluid mixtures in order to maintain different temperatures and compositions and hence different polymerization conditions in the various zones of the reactor. If the residence time of the polymer particles in formation is sufficient for them to pass through the reactor several times from the bottom upward and from the top downward before leaving it, they will have a relatively uniform bimodal or multimodal composition.

FIG. 1 also shows the possibility of inserting feed tubes (22) into the central nozzle, connected to injectors (23) spraying liquids into the reactor in the selected zones.

The fluid feed and removal devices and the helical turns may have various shapes and dimensions. FIGS. 2 to 6 show a number of examples which can be used in combination.

FIG. 2.a shows the projection of a cross section of the central part of the reactor (2) in which the device for feeding fluids into the reactor is provided by injection tubes (7), which are uniformly distributed along a helical gallery (24) and (25), against the side wall of the reactor and called the downward helical gallery, if it is wound in the opposite direction to the succession of the upward helical turns, and FIG. 2.b shows, in the same part of the same reactor (2), upward helical turns (13) of various dimensions and a fluid removal device composed of flared or curved conical nozzles, shown in full (31) and (32) or in cross section, (33) and (34), fitting into one another.

The three upper turns of the downward helical gallery, visible in full, shows their side (25) located against the reactor in the foreground, while only the part of the other turns of the gallery located in the background is shown with its inner sides (24) and its hollow sections (26). This helical gallery is fed via the inlet tubes (6) located, in this figure, every three half turns of the gallery.

To minimize the volume occupied by the downward helical gallery and thereby increase the space available for the fluidized bed, its height varies in wide proportions. It is a maximum (27) opposite the inlet tubes, and minimum (28), midway between the inlet tubes, where the fluid flow in the gallery is virtually nil. The width (29) of the gallery is constant and also the height (30) of the free helical space, between the turns and the gallery, called the downward helical channel.

The conical nozzles, from (31) to (34) are fixed around the inner outlet tubes (11) or in their flared (35) or curved (36) conical end. They are separated by fins, not shown, to guide the fluids rotating around them toward the reactor outlets and to ensure their uniform distribution. An insert (37) connects the upper nozzles to the lower nozzles in order to stiffen this set of nozzles called the central stack. To minimize the volume occupied by the central stack, the diameter of the conical nozzles narrows as they approach the insert (37), because the fluid upflow or downflow therein decreases. The arrows (41) and (42) show that the fluids travel from right to left in the foreground and from left to right in the background.

The dimensions of the various devices may vary from one zone to another of the reactor. Thus, in the frame (38), bounded by stars, surrounding the central zone of the reactor, removed via conical nozzles fitting into the conical ends (35) and (36) of the inner tubes (11.1) and (11.2), the pitch (17.1) of the upward helical turns, the heights (27.1) and (28.1) of the downward helical gallery, the height (30.1) of the downward helical channel and the diameter of the inlet tubes have been sharply reduced in order to increase the number of turns which the polymer particles must travel in this zone, called the separation or transition zone, and hence their transfer time between the lower zone and upper zone of the reactor, in order to strip them of the undesirable fluids before they pass into the other zone. Furthermore, the upper upward helical turn (13.1) in the frame (31) has been narrowed toward the center from a width (39) at the exterior and (40) at the interior, in order to enable all the particles to fall into the enlarged free side space and to prevent them from falling into the reduced free central space, thereby delaying the transfer of the particles located near the surface of the fluidized bed from the upper zone.

Since the helical gallery of the reactor in FIG. 2 is a second succession of helical turns oriented in the opposite direction to the first, it may be horizontal rather than vertical. In this case, the downward helical channel can be called the outer or side helical channel and the upflow helical channel can be called the inner or central helical channel. The dimensions of these channels must be adjusted so that the particle flows in the two channels are approximately equal. It is also necessary to account for the slowing of the polymer particles under the effect of gravity when they rise into the upper part of the reactor and, conversely, an acceleration of the polymer particles when they descend into its lower part. This causes a difference in thickness of the fluidized bed between its upper and lower parts, which becomes higher as the speed of rotation decreases. This may require shifting the central stack with regard to the cylindrical axis of symmetry of the reactor and altering the cylindrical symmetry of the helical turns. In order to prevent polymer particles from falling into the central stack during shutdowns, it also important that all the openings should be oriented downward.

FIG. 3 shows an axonometric perspective of the three lower flared conical nozzles, from (31.1) to (31.3), above the insert (37) and the three upper curved conical nozzles, from (32.1) to (32.3) below the insert (37), in order to show the fins (43) and (44) which separate them. The nozzle (31.2) has been raised and the nozzle (32.3) has been lowered to show better how they fit on the fins (43) and (44).

FIGS. 4.a and 4.b show a vertical section along plane BB′ and a horizontal section, along plane AA′ of the central part of another fluid removal device composed of cylindrical nozzles with cross sections (46) perforated with openings (9) and fitting into one another. Cross sections of fins (47), outside the nozzles, and of deflectors (48) inside the nozzles are illustrated along the openings (13). They convert the rotational component of the fluid flow (49) into a radial component, and the radial component into a longitudinal component directed toward the outlets of the stack. An insert (37) separates the upper part of the stack from its lower part and the inner tubes (11.1) and (11.2), remove, through their flared end, (35) and (36), the fluids issuing from the transition zone of the reactor, to purify them and thereby maintain distinct compositions of the fluids flowing in the upper part and the lower part of the reactor.

The number, position and dimensions of the openings (9), the fins (47) and the deflectors (48) may vary from one nozzle to another to obtain the desired fluid flow in the various parts or sections of the reactor.

FIG. 5 shows the projection of a vertical section and another model of the fluid removal device, in which part of the flared nozzles (33) has been replaced by a helical tape (50) wound on the longitudinal fins, not shown in the figure, arranged around the inner tube (11.1) and its flared end (35), the turns of the tape being flared and separated from their neighbors by deflectors or fins, not shown, to guide the fluids into the tube thus formed.

The possibility of making the outer edge of the tape (50) coincide with the hollow of the undulation or helical wave, which develops along the inner edge of the upward helical turns surrounding this tape, serves to reduce the width of the free central space and thereby increase the space available for the reaction. It is thereby possible to make the openings (9) of the cylindrical nozzles (8) and (46), shown in FIGS. 1 and 4, coincide with the hollow of the helical wave.

The device in FIG. 5 also serves to remove the fluid streams (51) and (52) from the reactor via a set of radial tubes (53) and (54) assembled like the spokes of a wheel, of which only the two located in the plane of the cross section are shown, and which exit the reactor through its side wall, not shown in the figure. This serves to lengthen the reactor without enlarging the fluid removal device, which is divided into several units interconnected by inserts (37) and (37.1).

FIG. 6 is a schematic view of a cross section of part of the transition zone of a reactor in which the upward helical turns are hollow and interconnected to form an upward helical gallery, which replaces the succession of upward helical turns and the fluid feed device along this zone of the reactor. The sections of the turns of this gallery comprise a main part, from (55.1) to (55.6), and a secondary part (56) of tubular shape, fed by tubes (57), concentric with the tubes (6) and serving to spray fine droplets of a liquid fluid close to the surface of the fluidized bed.

The gallery is characterized by the variable average height (58) of its sections, the heights (59) of the sections of the upflow helical channel, the pitch (60) of the gallery, its width (61) which may also vary, and the widths (62) and (63) of the free side and central space.

FIG. 6 also shows the cylindrical axis of symmetry (1) and the section (2) of the reactor housing, the sections of the flared (33) or curved (34) conical nozzles, the flared (35) or curved (36) conical end of the section of the upper or lower inner tube of the fluid removal device, and a schematic view of the fluid and the particles along its plane.

The small arrows (64) denote the movements of the polymer particles and the arrow lines (65) represent the fluid flow lines. The latter first descend into the free side space, if the injection of the fluids close to the side wall of the reactor is oriented slightly downward, in order to facilitate the fall of the polymer particles in this space. Then, since the speeds of rotation are of an order of magnitude higher than the travel speeds in the plane of the figure, these fluid flow lines (65) rise in the upflow helical channel by the height of one or more turns because they travel one or more turns before leaving therefrom. They must then fall back into the free central space approximately at the level of the nozzles which correspond to their inlet tube in the gallery. This may be lower, in order to maintain a downflow in the free central space to favor the descent of the polymer particles in this space.

Under the effect of the centrifugal force, the polymer particles accumulate along the side wall of the reactor to form a fluidized bed whereof the surface, at equilibrium, is close to a conical surface of which the cross section with the plane in FIG. 6 is the line (66) forming with the horizontal an angle (67) whereof the tangent is approximately the ratio of the centrifugal force to the force of gravity. The starting point of this line is determined at the bottom of the reactor by the particle detectors which adjust the outflow of these particles to maintain it at a sufficient distance from the fluid removal device.

Under the effect of the rotation, the polymer particles located in the upflow helical channel rise along the first helical turn (55.1) and then fall back into its free side space, if any. If the upflow is sufficiently high, that is if the speed of rotation is sufficiently high, this free side space generally very narrow or nil, will be insufficient to cause all the polymer particles to fall back. They accumulate upstream of the turn, thereby bringing the surface of the fluidized bed upstream closer to the center of the reactor, until the surface overflows into the free central space to enable the polymer particles to fall therein, thereby determining a new equilibrium level (66.1) upstream of the turn and thereby progressively filling, by turn after turn, the entire upflow helical channel, up to the top of the reactor.

The particles falling along the central edge of the gallery follow the direction (68) which is perpendicular to the equilibrium surface, thereby forming an angle (69) with the horizontal, whereof the tangent is approximately the ratio of the force of gravity to the centrifugal force. The difference between the upstream level and the downstream level, called the height of fall (70), determines a pressure difference between the upstream and downstream of the turn proportional to the height of fall and the resultant of the centrifugal force and the force of gravity. It is this pressure difference which determines the downflow rate of the particles in the free side space. It is approximately equal to the hydrostatic pressure of the fluidized bed along the height of the upflow helical channel, but there may be differences from one turn to another if the turn dimensions vary.

Thus the width (61.1) of the sections (55.4) and (55.5) of the gallery and the width (62.1) of their free side space have been sufficiently enlarged so that all the polymer particles can easily fall into the enlarged free side spaces, with a reduced difference between the upstream and downstream equilibrium level (70.3) and (70.4). The surface of the fluidized bed (66.4) and (66.5) does not permit the particles to fall back into the free central space. The unused part of the hydrostatic pressure of these two turns of the upflow helical channel is applied to the upper turn, thereby increasing the downflow rate of its free side space.

The upflow particles, which are located near the surface of the fluidized bed and which enter the zone above the sections (55.4) and (55.5) of the gallery, are forced to remain in the upper zone until they have approached the side wall of the reactor in order to fall into the free side space of these turns.

Similarly, the free side space of the sections (55.1) and (55.2) of the gallery having been eliminated, the particles falling into the free side space of the turn (55.3) are forced to rise. They can only enter the lower zone when they have approached the free central space of this turn.

FIG. 7 shows a simplified illustration of these features of the particle flow resulting from this sort of baffle. The figure shows the cross section of the fluidized bed running along the perforated side wall (3) of part of the wall of a reactor (2), around the cross sections (71) of a succession of upward helical turns. The fluid removal device, to the left of the fluidized bed, is not shown in the figure.

The pitch of the upper and lower helical turns, not shown in the figure, but symbolized by their spacing (73) is three times greater than the pitch of the turns, from (71.1) to (71.3) of the transition zone, symbolized by their spacing (73.1). They are at a constant distance (65) from the perforated cylinder (3), except in the transition zone, where the turns (71.1) and (71.2) are separated from it by a distance (65.1) and (65.2) respectively twice as large or as small. The turns (71.1) are also offset by a distance (74) toward the central nozzles and the turns (71.3) bear against the perforated cylindrical wall (3).

The fluidized bed has been divided into several annular zones: the central and side zones, upper and lower, of which the cross sections are respectively bounded by the frames from (77.1) and (77.4), are plotted using stars. The flow lines of the polymer particles are the sets of closed curves from (72.1) to (72.4) respectively in the upper and lower central and side part of the reactor. Their flow direction is indicated by arrows. The fluid flow lines are not shown.

Since the pitch of the helical turns of the transition zone is three times smaller, the rise of the polymer particles therein is three times slower. This is why their flow is only symbolized there by two upflow and downflow lines, compared with six in the other two zones. Outside the high turbulence zones which separate the upflow part from the downflow part of the particles, and which are symbolized by arrowed circles (75), the particle flow is presumed to be nonturbulent in this diagram.

Since the offset toward the center of the helical turns (71.1) prevents the particles issuing from the upper central zone (77.1) to fall into the transition zone, only the particles issuing from the upper side zone (77.2) can fall into the transition zone, and since the offset of the helical turns (71.3) against the perforated cylindrical wall (5) prevents them from falling into the lower zone, they must rise in the upper zone. For the same reason, the particles rising in the lower side zone (77.4) must fall back before entering the transition zone, and the particles rising in the lower central zone (77.3) must fall back before entering the upper central zone (77.1) at the risk of no-longer falling. Thus the transition zone is shared between the particles issuing from the upper side zone (77.2) and the lower central zone (77.3).

It has been found that in the absence of turbulence, the polymer particles flow in their respective zones. However, the inevitable turbulence causes a more or less rapid transfer from one zone to another, along the annular surfaces between the various zones. By suitably placing the fluid injectors (76) along the perforated cylindrical wall (3) of the reactor or the deflectors on certain helical turns, the turbulence can be increased locally, in order to accelerate transfers between the various zones according to the polymerization objectives.

A reduced free side space can be left between the sections of the turns (71.3) and the perforated cylindrical wall (3), to ensure a minimum direct transfer of polymer particles from the upper side zone (77.2) to the lower side zone (77.4), particularly to ensure the downward transfer of the heaviest particles. The lightest particles may also accumulate in the upper central zone of the reactor. To prevent this, an outlet tube can be provided for the polymer particles in this zone.

For the polymer particles to follow these flow patterns, it is important their the speed of rotation and hence for the energy that they receive from the fluid to be sufficient. Thus, the difference between the square of the fluid injection speed and its outlet speed from the fluidized bed multiplied by half of its flow rate must be sufficient to offset the energy losses due to friction of the particles and yield to the particles the potential energy that they acquire by rising in the upflow helical channel and which is then converted to turbulence and is lost during their fall.

For a reactor section of height H, the following equation can be written between the fluid injection speed in the reactor, Vᵢₙⱼ, and the average speed of rotation of the polymer particles, Vᵣₚ:
F_{fl}×Vᵢₙⱼ²=(k²×F_{fl}+K_{fr}×Dᵣ×S_{lf}×H)×Vᵣₚ²+2×K_{ef}×Dᵣ×g×L×P×H×Vᵣₚ (1)
where F_{fl} is the volumetric flow rate of the fluid in the given section; Dᵣ is the ratio of the apparent density of the particles and the fluid in the fluidized bed; S_{lf} is the average cross section of the fluidized bed; g is the gravitational acceleration; L and P are the width and pitch of the helical turns; k=Vₛ/Vᵣₚ generally close to 1, or Vₛ, is the outlet speed of the fluids from the fluidized bed; K_{ef} is an upflow efficiency factor of the helical turns, close to 1 if the turns are wide and close to one another, and K_{fr} is a friction coefficient equal to the percentage of rotational energy lost by the particles per unit of time due to friction.

The latter is dependent, inter alia, on the morphology of the particles, on the proximity to the helical turns and their aerodynamic properties. It can be estimated in pilot units which can simulate particle flow.

Since the fluid inlet speed is equal to its volumetric flow rate divided by the sum of cross sections of the injection tubes in the section considered, equation (1) can be used to evaluate the average speed of rotation of the particles as a function of the fluid flow rate.

Several other dimensions can be estimated, such as the radial speed of the fluid at the distance R from the center, V_{rad}; the upflow of the polymer particles, F_{asc}; the downflow in the free side space, Fₑₗₗ; and the downflow in the downward helical channel, F_{chd}:
V_{rad}=F_{fl}/(2×π×R×H×(1−C)) where C is the particle concentration in the fluidized bed;
F_{asc}=K_{ef}×L×P×Dₚ×Vᵣₚ where Dₚ is the apparent density of the polymer particles in the fluidized bed;
F_{chd}=k′×S_{chd}×Dₚ×Vᵢₙⱼ and Fₑₗₗ≅2π×R_{R}×Lₑₗₗ×Dₚ×\sqrt{2×g×H_{cha}}
where k′ is an efficiency factor close to 1, S_{chd} is the cross section of the downward helical channel, R_{R} is the radius of the reactor, Lₑₗₗ is the width of the free side space and H_{cha} is the height of the upflow helical channel.

The side downflows are added together and must be lower than the upflow for the helical turns concerned to be completely covered by the polymer particles. These equations must be adjusted if the height of the upward channel and the dimensions of the helical turns vary.

### FIRST EXAMPLE

### Copolymerization OF Ethylene Without Diluent

The high cooling capacity of this polymerization method is suitable for polymerizing gas phase polyethylene without having to dilute the ethylene with an unreactive fluid.

FIG. 8 shows, at the left, three sections of the half-section of the top, middle, and bottom of a reactor (2), with its cylindrical axis of symmetry (1), comprising two main zones, whereof only the ends are shown, namely the upper and lower ends, and a central zone, shown in full in the middle section.

The central stack comprises cylindrical and conical nozzles of cross section (8), provided with openings (9), two main fluid removal tubes (8.1) and (8.2), two inner tubes for removing the fluids from the central zone, (11.1) and (11.2), terminating in cones (35) and (36), an insert (37) dividing the central zone into two sections, and a feed tube (22) for spraying the comonomer on the surface of the fluidized bed via injectors (23) in the upper zone of the reactor.

The main feed device comprises a downward helical gallery, of which the sections (26) are shown, welded to the side wall of the reactor (2) and fed via tubes (6), and the upward helical turns, of sections (71), are uniformly distributed against the inner wall of the downward gallery, with the exception of the pairs of turns (71.1) and (71.2), which are located at the ends of the central zone, whereof the pitch is reduced and which are separated from the downward helical gallery, whereof the height is reduced.

FIG. 8 also shows the device (19) for injecting catalyst, prepolymerized if necessary, the outlet tube (20) for the polymer particles, the fluidized bed level detectors (21), the surface of the fluidized bed (66), the polymer particles indicated by small arrows (64) showing their travel direction in the plane of the figure, the fluid flow lines (65) and circles (75) indicating the turbulence.

In the feed and recycle flowchart shown in FIG. 8, the pure ethylene feed (84) is at the height of the inlet tube (6.2), the feed of liquid comonomer (85), generally butene or hexene, occurs via the central feed tube (22) in the upper zone, and that of a polymerization control reagent, (86), generally hydrogen, occurs in the fluid recycle circuit of the lower zone.

The fluid flow (87) issuing from the lower central zone, and which is removed via the lower inner tube (11.2), has a comonomer content reduced by the addition of pure ethylene (84). It is stripped, in the cyclone (88), of any solid particles entrained by the fluid, compressed in the compressor (89), cooled in (90) and stripped, in the absorbers (91), of the undesirable part of the polymerization control reagent issuing from the lower zone, before being recycled to the upper central zone.

The fluid stream (92), issuing from the upper central zone, contains comonomer from the upper zone. This flow is removed via the upper inner tube (11.1). A part thereof is sent to the recycle circuit from (88) to (91), another part may be sent to the upper zone via the control valve (97.1) and the remainder, if the comonomer content of the central zone is to be reduced significantly, is sent to a separator (93) which sends a stream (94) of ethylene saturated liquid comonomer to the comonomer feed circuit and a stream (95) of ethylene stripped of its comonomer to the lower central zone. Since the quantity of comonomer to be recovered at the bottom of the column is generally small and may therefore be highly diluted in large quantities of ethylene, the separator (93) may be a simple fractionation column with low reflux operating at high pressure, obtained by the compressor (96), preceded by a cyclone (not shown).

Noteworthy is the intersection of the streams from the central zone, which serves to minimize the quality of flows that must be purified and the bypass equipped with a control valve (97.2) which serves to differentiate between the hydrogen content of the upper zone and the central zone.

The liquid stream (98) issuing from the upper zone is removed via the main tube (8.1). It is stripped of any solid particles in the cyclone (99), cooled in (100) and separated from any condensate, of ethylene saturated comonomer, in the separator (101). The light gaseous fraction (102) is compressed by the compressor (103) and recycled to the upper zone. The condensate (104) is recycled to the comonomer feed circuit.

The fluid stream (105) from the lower zone is removed via the main tube (8.2), cooled in (106) and stripped of any polymer particles in (107) before being recycled by the compressor (108) to the lower zone. The polymer particles removed via the outlet (20) are stripped of part of their ethylene in the cyclone (109) before being transferred in (110) to conventional recovery means. The expanded ethylene is recycled by the compressor (111) to the lower circuit.

Flow control devices (112) are suitably placed on the main feed tubes to guarantee an appropriate feed difference between the various sections of the reactor, for example, to favor a fluid downflow in the free central space to reduce the risk of particle entrainment in the central stack.

For better visualization, FIG. 9 shows, projected on the side wall of the central part of the reactor, the 360° development of the upward helical turns (71) and of the inner wall of the downward helical gallery (24), with its injection tubes (7). The fluid flows travel in the direction of the arrows, from right to left and, for the clarity of the drawing, the vertical scale is double the horizontal scale. Thus the feed tubes (6) appear in the form of ellipses. To offset them by 90°, they are arranged every 7/4 turns of the gallery, where its height (27) is a maximum. It is a minimum (28) midway between the tubes (6).

The downward helical channel, located between the turns (24), at a constant height (30) except in the separation zones, where the heights (30.1) and (30.2) are reduced and the cross sections of the turns or fractions of upward helical turns (71) travel ⅝ of a turn and project, in pairs, from each tube (6), in order to feed them with a coolant fluid via these tubes, if necessary.

FIG. 10 shows the particle flows (72) in the three reaction zones. For the clarity of the drawing, the horizontal scale has been enlarged and the downward helical gallery and channel have been broken down into a perforated wall (3) and a free side space.

In the absence of turbulence, the particles in the central annular zones, bounded by the frames plotted using stars (77.1), (77.3) and (78), flow in closed circuits (72.1), (72.3) and (79.1), and part of the particles located in the side zones also flow in closed circuits, (72.2), (72.4) and (79.2), if the upflow generated by the helical turns (71.1) and (71.2) is lower than the downflow of the downward channel of the adjacent zones. The other particles located in the side zones pass through the reactor from the top downward and from the bottom upward, following the circuits (80). In practice, the turbulence ensures a mixing of the particles in the various annular zones of the reactor. However, the particles falling along the surface of the fluidized bed from the upper zone, and which have been impregnated with the comonomer injected by the injectors (23), must pass through the upper side zone, where their comonomer content is progressively reduced, before entering the central zone, where their comonomer content is further reduced.

For illustration, the orders of magnitude of the various values can be estimated, for an industrial reactor having a volume of about 70 cubic meters, 15 meters high and 2.5 meters in diameter. These values, which depend on a large number of parameters, may vary significantly according to the design of the reactor and the morphology of the particles, which depend on the catalyst system used. They must be adjusted with the help of pilot units designed to test the flow of polymer particles as a function of the various parameters.

Each main zone comprises 11 inlet tubes (6) 0.25 m in diameter, each feeding a 0.56 m high section of the reactor via a downward helical gallery having an average pitch of 0.32 m, making 7/4 turns between each tube, having a width of 0.1 m, a maximum height of 0.32 m opposite each tube, and a minimum height of 0.04 m midway between the tubes, leaving a free height of 0.16 m for the downward helical channel. The central zone comprises three identical sections, located between two 0.28 m high sections fed by the two inlet tubes (6.1) and (6.2) 0.16 m in diameter, through a downward helical gallery having an average pitch reduced by half, a maximum height of 0.16 m and a minimum height of 0.02 m, leaving a free height of 0.08 m for the downward helical channel.

For an outside diameter of the central stack of 0.6 m in the central zone and 1 m at the ends of the reactor, and for an inside diameter of the helical turns (71) varying progressively from 1.1 to 1.5 m, the width of the free central space is 0.25 m and the volume of the fluidized bed is about 45 cubic meters. The average spacing of the upward helical turns is about 0.45 m and their width and pitch vary respectively from 0.6 and 0.15 m in the central zone to 0.4 and 0.24 m at the ends of the reactor.

If the average speed of rotation of the polymer particles varies between 7 and 8 m/sec, considering a lower resistance when the width of the turns decreases and if their apparent density in the fluidized bed is 350 kg per cubic meter, the polymer particle upflow is about 600 t/h. The average centrifugal force is 5 to 6 times the gravitational acceleration, which, for an average spacing of 0.45 m of the upward helical turns, gives a height of fall of less than 0.1 m, which is small enough compared with the width of the turns of 0.4 to 0.6 m.

For a fluid pressure of 25 bar and a flow rate of 1 cubic meter per second via the main inlet (6), the fluid injection speed must be about 16 m/sec, if the friction coefficient, that is, the loss of energy of the polymer particles due to friction, is 5%/sec. It must be about 18 m/sec if the energy loss due to friction is twice as much.

The total fluid flow rate is 26 cubic meters per second, or about 3000 t/h, providing high cooling capacity and requiring about 80 injection tubes (7) 0.03 m in diameter, per 0.56 m section of the reactor. The average fluid residence time in the fluidized bed is less than 2 seconds, and that of the polymer particles is about 15 minutes, if the polyethylene production capacity is about 60 t/h.

The radial speed of the fluid close to the surface of the fluidized bed is about 0.5 m/sec, which is sufficiently low for good separation between the fluidized bed and the fluid, taking account of the centrifugal force. The average particle speed in the downward helical channel may exceed 10 m/sec, giving a side downflow of polymer particles of about 200 t/h, sufficiently low for filling the upflow helical channel and sufficiently high for removing aggregates and any polyethylene skins, whereof the risk of formation is reduced by the speed of flow of the particles along the walls.

The number of passages made by the polymer particles in each zone of the reactor depends on the turbulence and the pitch of the upward helical turns (71.1) and (71.2). It may be increased or decreased by increasing or decreasing the pitch of these turns, according to whether priority is assigned to the uniformity of the polymer particles or the differentiation of the reactor zones.

If the fluid pressure must be increased, for example to 45 bar, to increase the reaction rate, in order to reach the desired production capacity of 60 t/h, and if the injector cross section is unchanged, the volumetric flow rate of fluid and the injection speed must be reduced by about 15% to preserve the same speed of rotation of the polymer particles. Since the total fluid flow rate exceeds 4000 t/h, it may be reduced if necessary, by reducing the diameter or the number of injection tubes, to increase the injection speed with a lower flow rate.

This method can operate with a fluid pressure above the critical pressure of ethylene, to obtain high polyethylene production capacities in smaller reactors. Since the volume of the fluidized bed is smaller, the polymer particle residence time therein is shorter. For example, for a pressure of 80 bar and a reactor 1.8 m in diameter and 10 m high, the volume of the fluidized bed is only about 15 cubic meters. The volume of fluid injected into the reactor may be about 8 to 10 cubic meters per second, if the desired production capacity is 60 t/h of polyethylene, and the average particle residence time in the reactor is only about 5 minutes, reducing the number of particle passages in each zone of the reactor and hence their uniformity.

FIG. 11 shows an enlargement of a central zone of the reactor reduced to only two sections fed by the inlet tubes (8.1) and (8.2) to show the flow equilibrium and how the polymer particles issuing from the upper zone are stripped of comonomer before entering the lower zone.

It should first be observed that the inner liquid comonomer spray tube (23) is sufficiently far from the central zone to avoid sending particles impregnated with comonomer therein, these particles first having to rise in the upper side zone before entering the transition zone.

The particle downflow in the free side space and the downward helical channel of the pair of helical turns (71.1) is equal to the flow rising in the upper zone of their upward channel, depending on the pitch of these turns, or for example 250 t/h. Only a fraction of the part passing into the downward helical channel with 0.08 m height of the pair of turns (71.2), for example 60% of 100 t/h, and a fraction, entrained by the turbulence, passing through its free central space, for example 40% of 150 t/h, can reach the lower zone of the reactor, or about 120 t/h, entraining with them, for a pressure of 25 bar, 6 to 7 t/h of fluid which are purged by the twice 55 t/h of fluid fed via the inlets (6.1) and (6.2).

If the polyethylene production capacity is 60 t/h, the quantity of pure ethylene introduced at (84) exceeds the 55 t/h introduced into the tube (6.2). The difference goes into the tube (6.1), and also the quantity of purified ethylene (95) for example 20 t/h. The fluid stream (87), containing little comonomer and the unpurified fraction of the fluid stream (92) are introduced at (89) to supplement the feed of the tube (6.1), the difference going to the upper zone via a flow control valve (112.1).

To avoid diluting the fluid stream (87) by the stream (92) containing more comonomer, this difference can be introduced directly into the recycle circuit of the upper zone upon its outlet from the reactor by the bypass (97.1) in FIG. 8. If the quantity of purified fluid (95) is nil and if the quantity of pure ethylene (84) stream (87) is sufficient to feed the central zone, shown here by the sole inlets (6.1) and (6.2), the entire stream (92) can be sent to the main upper circuit.

If the downflow particle residence time in the transition zone is insufficient to strip them sufficiently of their comonomer, the transition zone can be enlarged as shown FIG. 8.

Since the main lower zone is not fed with pure ethylene, there is a fluid deficit in this zone, which can only be filled by a fluid stream (115) which falls into the free central zone, about 30 t/h, generating a downflow fluid stream (115) in the free central zone at a speed of about 0.5 m/sec favoring the fall of the particles in this free central space. This downflow fluid stream can be maintained up to the bottom of the reactor with flow controllers (112) as shown in FIG. 8. It can be obtained in the upper part of the reactor similarly.

In FIG. 11 the central edges of the helical turns (71) of the two main zones have been raised to enable the stream of polymer particles falling into the free central space to flow along the inner surface of these edges and thereby preventing the occurrence of a particle-free zone therein, which would favor the formation of polyethylene skin. It should also be observed that the downward helical gallery has been blocked at (26.1) and (26.2), midway between the feed tubes (6.1) or (6.2) and the tubes (6) of the adjacent zones, in order to operate at a different pressure in the gallery of the transition zone, thereby increasing or decreasing the fluid flow without varying the flow rate in the adjacent zones.

In case of major malfunction, for example, the shutdown of a compressor, an unreactive gas, such as nitrogen, can be injected downstream of the defaulting compressor and the cyclone (109) outlet can be connected to the safety flare in order to depressurize the reactor while purging it with an unreactive gas. The reaction can be stopped in a few seconds by injecting a catalyst poison into each recycle circuit. Finally, if the reactor must be emptied completely and very rapidly, it is advisable to provide more particle outlets (20), including at least one in the transition zone and another close to the top of the reactor.

### SECOND EXAMPLE

### Copolymerization of Ethylene with Diluent

If the reaction rate is too high, it can be slowed down by diluting the ethylene with an unreactive fluid.

FIG. 12 shows an identical reactor to the one in FIG. 8, to which has been added, in the main lower part of the central stack, a central tube (22.1) for feeding liquid diluent (118) lighter than the comonomer, for example, propane or isobutane, connected to injection tubes (23.1), for spraying fine droplets thereof on the fluidized bed.

The fluid stream (105) leaving the main lower tube (8.2) contains diluent. This is why a separator (119) can be used, before recycling it, to separate it from a condensate (120) which, in addition to the diluent and ethylene, has absorbed small quantities of comonomer present in the main lower zone of the reactor. Part of this condensate (120) is recycled with the fresh diluent (118) via the central feed tube (28.1), and the other part to be stripped of comonomer is sent to the separation column (93). This column can also be fed with part of the condensate (104) containing comonomer saturated with diluent and ethylene, to reduce the quantity of diluent present in the upper zone. The gaseous fraction (95) recovered at the top of the column (93) is ethylene saturated with diluent and it is sent to the lower central zone. The liquid fraction (121) is recycled with the fresh diluent (118) via the lower feed tube (22.1). The liquid fraction (94) recovered at the bottom of the column (93) is comonomer mixed with quantities of diluent and ethylene which depend on the operating conditions of the comonomer. This fraction (100) is recycled to the upper zone with the fresh comonomer (85) via the central feed tube (22).

The main lower zone is purified by absorption of the comonomer by the diluent in the entirety of the zone, thereby reaching a relatively high level of purity.

The data concerning the fluids depend on the pressure, the type of diluent and the quantity of liquid recycled which, by cooling the fluidized bed, substantially reduces the quantity of liquid that must be recycled, hence the need to increase the injection speed, to obtain a sufficiently high speed of rotation of the polyethylene particles. The reactor can be lengthened or the central stack diameter can be reduced. The main drawback is the additional cost incurred by introducing a diluent.

If the diluent concentration increases, the ethylene may be completely dissolved at the recycled fluid injection temperature and the recycled fluid fed to the reactor may thus be liquid. The fluid injection speed into the reactor must be adjusted to the increase in its density and to the significant reduction of its volumetric flow rate. The centrifugal force must be sufficient to separate the liquid fluid from the polymer particles at the outlet of the fluidized bed, despite its higher density, if the reactor is completely in liquid phase.

However, the pressure in the reactor may be such that the liquid therein is at boiling point, allowing the filling of the free central space with the gaseous fluid produced by its boiling. In this case, it is still possible to have different temperatures in the various zones by varying the diluent concentrations in the various zones. However, in a startup period the evaporation of the fluid is insufficient to provide the necessary flow rate for its satisfactory rotation of the fluidized bed. It is therefore necessary to start in a completely liquid phase or by injecting gas and, to facilitate removal of the comonomer, it maybe advisable to use a heavier diluent than the comonomer so that the latter is preferentially distilled.

### THIRD EXAMPLE

### Copolymerization of Propylene

To produce block copolymers of propylene and ethylene, the characteristics of the reactor must take account of the need for good separation between the main zones and the need to polymerize a sufficient proportion of propylene, despite its lower reaction rate, which justifies use of a very long reactor optionally comprising a fluid removal device at the middle of the reactor via radial tubes. Considering its length, it may be advisable to use a horizontal reactor.

The top of FIG. 13 illustrates the lower cross section of such a horizontal reactor, comprising a first succession of helical turns (71), moving the particles from left to right, and a helical gallery (26) whereof one side is prolonged by a second succession of helical turns (122) moving the particles from right to left. These successions of turns respectively bound a central or inner channel and a side or outer channel whereof the cross sections are designed to approximately equalize the polymer particle flow rates respectively to the right and to the left, while maintaining a slight differential in order to increase the thickness of the fluidized bed, whereof the cross section of its surface (72), where the central stack is the narrowest, is shown.

The transition zone to the left of the insert (37) is connected to two concentric outlet tubes (11.1) and (11.2), terminating in flared cones (35) and (36). Pure ethylene (84) fed via the inlet (6.1) is removed via the flared cone (36) prolonged by the tube (11.2). It is slightly contaminated with the propylene still present in the polymer particles issuing from the right. This fluid (87) is separated from any polymer particles in the cyclone (88), compressed in (89) and cooled in (90) to be recycled via the inlet (6.2) in order to purge the polymer particles issuing from the right of the propylene that they entrain. The fluid stream (92) removed via the flared cone (35) prolonged by the tube (11.1) and containing substantial quantities of propylene, is stripped of any solid particles (92.1), cooled and sent to the separation column (93). The ethylene (95) leaving at the top of the column is compressed in (96) and recycled by the compressor (108) to the main left zone.

This zone, which serves to polymerize the ethylene fed at (84), only comprises three inlet tubes (6), taking into consideration the higher reaction rate of ethylene and the polyethylene content of the block copolymer which is generally low. The fluid (105) issuing from this zone, is removed via the main tube 8.2, cooled in (106), separated from any polymer particles in (107) and recycled by the compressor (108) through the three inlet tubes (6).

The bottom of the separation column (96) contains liquid propylene (94), stripped of its ethylene. It is transferred with the fresh propylene (85) to the reactor via the tubes (22) and (22.1), to be sprayed therein by the injectors (23). The propylene gas injected via the inlet tube (6.4) is contaminated with small quantities of ethylene entrained by the polymer particles issuing from the left. It is removed via the central lower tube (11.3) which is connected to a radial tube (53) for removing the fluid (126) laterally at the middle of the reactor. This fluid stream (126), slightly contaminated with ethylene, is stripped of any solid particles in (127), compressed in (128) and cooled in (129) to be recycled via the inlet tube (6.3) to the left of the inlet tube (6.4) in order to purge the polymer particles issuing from the left of the entrained ethylene. This propylene loaded with ethylene is removed via the tube (11.1) at the same time as the ethylene loaded with propylene to be separated in the separation column (93).

The main reaction zone at the right serves to polymerize the propylene fed at (85). This very long zone comprises, for the removal of the propylene gas, in addition to the outlet via the main central tube (8.1) to the right of the reactor, side outlets, composed of a set of radial tubes (54), located in the same plane as the radial tube (53), and whereof only one is shown. Another radial tube, located in the same plane and not shown in the figure, feeds the liquid propylene to the tube (22.1). The propylene gas (98) and (98.1) respectively removed via the main tube (8.1) and the radial tubes (54) is stripped of any solid particles in (99), cooled in (100), stripped of its condensate in (101) and recycled by the compressor (103) via the inlet tubes (6).

In order to avoid interrupting the flows of the fluidized bed to the right and to the left, the space between the radial tubes (53) and (54) comprises fins which guide the particle streams in the appropriate directions.

Thus the transition zone, which is located between the two main zones, comprises four inlet tubes from (6.1) to (6.4). It is divided into three transition sections, whereof the central section, connected to the outlet tube (11.1) of the cone (35), is fed via the inlets (6.2) and (6.3), by the compressors (89) and (128) which compress the streams (87) and (126), respectively containing only a low propylene or ethylene content and issuing from the other two transition sections, connected to the outlet tubes (11.2) of the cone (36) and (11.3), terminating in a radial tube (53). Only the stream (92) from the central section, a mixture of ethylene and propylene, is purified and separated in a separation column (93) before being recycled.

This transition zone device with three sections with crossed recycling between the central section and the other two sections, is suitable for improving the separation between the two main zones, while limiting the quantity of fluid that must be separated in the separation column (93). As, in general, the degree of purity of the propylene must be higher than the degree of the purity of the ethylene, ⅔ of the transition zone are fed with propylene and one-third with ethylene in this example.

Since the reactor is horizontal, the central stack may be a nozzle provided with several rows of side openings (9) located on its sides and its lower part and equipped with fins guiding the fluid streams (133) to the outlet tubes. It should also be observed that with a reactor diameter of about 2 m and an average particle speed of rotation of 10 m/sec, the thickness of the fluidized bed at the bottom of the reactor is only about two-thirds of the thickness at the top of the reactor, due to the difference in potential energy and hence in the speed of the particles, which is not negligible. It is therefore advisable to off-center the central stack and, optionally, alter the cylindrical symmetry of the two sets of helical turns to better match the shape of the fluidized bed. Furthermore, since the lateral movement of the polymer particles must not resist the force of gravity, the spacing between the helical turns (71) and (122) can be increased, to reduce the friction resistance. This helps to avoid an excessively high fluid injection speed.

Since the reaction rate and heat of reaction of the propylene are lower and the cooling of the fluidized bed is partly provided by the evaporation of the liquid propylene sprayed by the central tubes (22) and (22.1), the propylene gas flow rate is low, thereby allowing the lengthening of the main right hand zone of the reactor, in order to polymerize more propylene. If the volume of this zone must be increased further, the reactor can be slightly widened, while maintaining the surface (72) of the fluidized bed approximately at the same level.

The other operating characteristics are similar to the preceding examples and can be estimated similarly. These various examples demonstrate the flexibility of this polymerization method, which can be applied to most fluidized bed catalytic polymerizations, gaseous or liquid.

1-31. (canceled)

32. A method for the polymerization of an olefin in a fluidized bed reactor comprising:
providing a fluidized bed reactor having an outer sidewall extending longitudinally of said reactor, an internal removal conduit extending longitudinally of said reactor coaxially with said outer wall and providing an annular reaction zone between said outer sidewall and said internal removal conduit, and a plurality of helical baffles spaced longitudinally along said reactor in said annular reaction zone and extending laterally from said removal conduit and terminating in said reaction zone short of said outer sidewall to provide a side free space between said baffles and said outer sidewall;
introducing a polymerization catalyst system into the reaction zone of said fluidized bed reactor;
introducing a reactive fluid comprising at least one olefin monomer into said fluidized bed of the reactor through and into the annular reaction zone through a plurality of openings in said outer sidewall extending longitudinally along said outer sidewall;
operating said reactor under polymerization conditions effective to polymerize said olefin monomer in the presence of said catalyst system to produce a slurry of polymer particles within said reaction zone which flow spirally along said helical baffles to divert at least a portion of said polymer particles outwardly to the side free space between said helical baffles and said sidewall;
flowing said polymer particles along said side free space to a recovery position within said polymerization reactor;
withdrawing said polymer particles from said recovery position to recover said polymer particles from said reactor;
flowing unreacted olefin monomer into said removal conduit and recovering said unreacted olefin monomer from said removal conduit; and
recycling at least a portion of said recovered olefin monomer to the said fluidized bed reactor.

33. The method of claim 32 wherein said fluidized bed reactor has an external wall extending longitudinally of said reactor and spaced outwardly of said outer sidewall to define an annular feed reactor space between said outer sidewall and said external wall and wherein said reactive fluid is introduced through a plurality of injection tubes in said external wall and into said annular feed space and thence through said plurality of openings spaced longitudinally along said outer sidewall into said reaction chamber.

34. The method of claim 33 wherein said annular reactive space is provided with a plurality of partitions to divide said feed space into a plurality of feed compartments extending longitudinally along said feed space.

35. The method of claim 34 wherein a plurality of reaction fluids having different compositional make-ups are introduced into said feed compartments.

36. The method of claim 32 wherein said helical baffles are arranged in at least two galleries of said helical baffles and further comprising operating said reactor to flow said reactive fluid within said reactor in one spiral direction in one of said galleries and flowing said reactor fluid in another of said helical galleries in a spiral direction opposite to the flow of said reactive fluid in said first gallery.

37. The method of claim 32 wherein said reactive fluid comprises ethylene monomer.

38. The method of claim 37 wherein said reactive fluid comprises ethylene monomer and a C₃⁺ alpha olefin comonomer.

39. The method of claim 32 wherein said fluidized bed reactor is configured in a vertical orientation in which said polymer particles are withdrawn from said polymerization reactor at a recovery position adjacent the bottom of said reactor and wherein said unreacted olefin monomer is recovered from said removal conduit at an upper location of said removal conduit and separately recovered from said removal conduit at a lower location of said removal conduit.

40. The method of claim 39 wherein the unreacted olefin monomer recovered from each of said upper and lower positions is recycled separately back to said fluidized bed reactor.

41. A method of polymerization in a fluidized bed comprising a cylindrical reactor; a device for injecting a polymerization catalyst, causing the formation of polymer particles in the presence of a gaseous or liquid reactive fluid; at least one outlet arranged in the wall of said reactor for withdrawing said polymer particles in suspension in said fluidized bed; a detection device for detecting the surface of said fluidized bed, said outlet being servocontrolled by said detection device in order to adjust the outgoing flow rate of said polymer particles to maintain said surface at a distance from a device for removing said reactive fluid; a recycle device for recycling into said reactor, via a feed device, said reactive fluid removed by said removal device; a device for recovering said polymer particles withdrawn from said reactor after having separated them from said reactive fluid; characterized in that:
said feed device is designed to inject said reactive fluids into the reactor, in a uniformly distributed manner, along the side wall of said reactor in directions which do not deviate by more than 30° from the horizontal and from the tangent to said side wall, entraining said reactive fluid and said polymer particles in a rotary movement whereof the centrifugal force thrusts said polymer particles toward said side wall;
said removal device surrounds the cylindrical axis of symmetry of said reactor and is provided with uniformly distributed openings between its base and its top, designed to remove said reactive fluid in a uniformly distributed manner between the base and the top of said reactor; and
said reactor comprises at least one succession of fixed helical turns, running along said side wall of said reactor, distributed between the base and the top of said reactor, surrounding said removal device, at a certain distance therefrom, said helical turns being oriented in the direction for entraining said polymer particles rotating in the helical space between the walls of said helical turns and the free central space between said helical turns toward the top of said reactor, and said removal device enabling said polymer particles to fall back into said free central space without entering said removal device, the speed of rotation and hence said centrifugal force preventing said polymer particles from being entrained by said reactive fluid in said removal device, said reactive fluid and said polymer particles, under the action of said centrifugal force and said helical turns, thereby forming a rotating vertical fluidized bed.

42. The method of claim 41, wherein:
said feed device is divided into at least two distinct parts for feeding at least two distinct zones of said reactor with at least two different mixtures of reactive fluids;
said removal device is divided into at least three distinct sections, each connected to an outlet tube leaving said reactor and suitable for separately removing from said reactor said different mixtures of said reactive fluids entering each of said distinct sections, one of said distinct sections being a separation section located between the other two and suitable for removing from said reactor said reactive fluids which have mixed together in the separation zone between said two distinct zones of said reactor; and
said recycle device is capable of separately treating and recycling said different mixtures of said reactive fluids.

43. The method of claim 42, characterized by the division of said separating section of said removal device into at least two subsections in order to recycle said mixed reactive fluids issuing from one of said subsections into said reactor at the level of the zone of said reactor feeding another said subsection.

44. The method of claim 42, characterized by the division of said separating section of said removal device into three subsections, in order to purify, separate into two distinct streams, and recycle via said recycle device into said reactor, said mixed reactive fluids issuing from the central subsection located between the other two said subsections, said mixed reactive fluids issuing from the other two said subsections being recycled without passing through a purification and separation device, at the level of the zone of said reactor feeding said central subsection.

45. The method of 44, wherein said feed device comprises at least one helical gallery, running along said side wall inside said reactor and oriented in the opposite direction to said helical turns, said helical gallery being suitable for injecting into said reactor, via injection devices uniformly distributed along its walls, said reactive fluids fed to said helical gallery by feed tubes uniformly distributed along said gallery and passing through said side wall of said reactor.

46. The method of 41 in which said reactor is horizontal and comprises a second succession of helical turns concentric with said first recited succession of helical turns, the helical turns of said second succession being oriented in the opposite direction to the helical turns of said first succession, in order to entrain said polymer particles toward the opposite end of said reactor, said polymer particles thereby flowing from one end of said reactor to the other.

47. The method claim 41 wherein said reactor comprises a free side space between said helical turns and said side wall of said reactor, through which said polymer particles can fall by gravity toward the bottom of said reactor, said free side space being sufficiently narrow for only part of said polymer particles which have risen in said reactor to fall back therein, the other part having to fall via said free central space.

48. The method of claim 47, characterized by the absence of a said free side space between said side wall of said reactor and said helical turns along at least one said helical turn in order to prevent said polymer particles from falling back into said free side space along said helical turn, forcing all of said polymer particles to fall back into said free central space between said helical turn and said removal device.

49. The method claims 47 wherein a said free side space is sufficiently wide along at least one said sufficiently wide helical turn to enable all of said polymer particles to fall back into this free side space along said helical turn and to prevent the falling of said polymer particles into said free central space along said helical turn.

50. The method of claim 41 characterized by a hollow shape of at least part of said helical turns which are connected to said side wall of said reactor by tubes for feeding them with a reactive fluid or coolant.

51. The method of claim 50, in which at least a portion of said reactive fluid injected by said feed device is in gaseous form, and said reactive fluid or coolant is a liquid, characterized in that it comprises injection devices distributed along said hollow helical turns, suitable for spraying said liquid in fine droplets into said reactor.

52. The method of claim 41 in which at least a portion of said reactive fluid is in gaseous form, characterized in that it comprises at least one tube passing through said removal device and equipped with injectors for spraying fine droplets of a reactive fluid or coolant on at least part of said surface of said fluidized bed.

53. The method claim 41 wherein at least part of said removal device comprises a succession of flared nozzles, fitting into one another and separated from one another by fins or deflectors which guide said reactive fluids rotating in said reactor toward at least one of said outlet tubes.

54. The method of claim 41 wherein at least part of said removal device comprises a cylindrical or conical nozzle perforated with numerous openings equipped with fins or deflectors which guide said reactive fluids rotating in said reactor toward at least one of said outlet tubes.

55. The method of claim 41 wherein at least part of said removal device comprises at least one helical tape wound on itself and wherein the successive turns are separated from one another by fins or deflectors which guide said reactive fluids rotating in said reactor toward at least one of said outlet tubes.

56. The method of claim 41 wherein the dimensions of said helical turns vary from one turn to another for at least a portion of said helical turns along said reactor, in order to adjust the flow of said polymer particles in said reactor.

57. The method claim 41 wherein said reactor comprises at least one device for producing turbulence in at least one location of said fluidized bed, in order to increase at said location the mixing between said polymer particles flowing in the space close to said side wall of said reactor with those of the space close to said surface of said fluidized bed.

58. The method of claim 41 wherein at least a portion of said helical turns have a raised inner edge, to bound a central inclined wall, in order to enable said polymer particles falling back into said free central space to flow along said central inclined walls.

59. The method of claim 41 wherein said reactive fluid contains at least one olefin.

60. A polymerization fluidized bed comprising a vertical cylindrical reactor; a device for injecting a polymerization catalyst; a device for feeding a reactive fluid; at least one outlet for the polymer particles in suspension in said fluidized bed provided in the wall of said reactor and servocontrolled by a device for detecting the surface of said fluidized bed; a device for removing said reactive fluid; a recycle device for said removed reactive fluid; a device for recovering said polymer particles withdrawn from said reactor after having separated them from said reactive fluids; characterized in that:
said feed device comprises a plurality of injection devices which are uniformly distributed along the side wall of said reactor in directions which do not deviate by more than 30° from the horizontal and from the tangent to said side wall;
said removal device surrounds the cylindrical axis of symmetry of said reactor and is provided with uniformly distributed openings between its base and its top; and
said reactor comprises at least one succession of fixed helical turns, running along said side wall of said reactor, distributed between the base and the top of said reactor, surrounding said removal device, at a certain distance therefrom, said helical turns being oriented in the direction for entraining said polymer particles rotating in the helical space between the walls of said helical turns toward the top of said reactor.

61. The polymerization fluidized bed of claim 60, wherein:
said feed device is divided into at least two distinct parts for feeding at least two distinct zones of said reactor with at least two different mixtures of reactive fluids;
said removal device is divided into at least three distinct sections, each connected to an outlet tube leaving said reactor and suitable for separately removing from said reactor said different mixtures of said reactive fluids entering each of said distinct sections, one of said distinct sections being a separation section located between the other two and suitable for removing from said reactor said reactive fluids which have mixed together in the separation zone between said two distinct zones of said reactor; and
said recycle device is capable of separately treating and recycling said different mixtures of said reactive fluids.

62. The fluidized bed of claim 61, characterized by the division of said separating section of said removal device into at least two subsections in order to recycle said mixed reactive fluids issuing from one of said subsections into said reactor at the level of the zone of said reactor feeding another said subsection.

63. The fluidized bed of claim 61, characterized by the division of said separating section of said removal device into three subsections, in order to purify, separate into two distinct streams, and recycle via said recycle device into said reactor, said mixed reactive fluids issuing from the central subsection located between the other two said subsections, said mixed reactive fluids issuing from the other two said subsections being recycled without passing through a purification and separation device, at the level of the zone of said reactor feeding said central subsection.

64. The fluidized bed of claim 63, wherein said feed device comprises at least one helical gallery, running along said side wall inside said reactor and oriented in the opposite direction to said helical turns, said helical gallery being suitable for injecting into said reactor, via injection devices uniformly distributed along its walls, said reactive fluids fed to said helical gallery by feed tubes uniformly distributed along said gallery and passing through said side wall of said reactor.

65. The fluidized bed of claim 60 comprising a free side space between said helical turns and said side wall of said reactor, through which said polymer particles can fall toward the bottom of said reactor.

66. The fluidized bed of claim 65, characterized by the absence of a said free side space between said side wall of said reactor and said helical turns along at least one said helical turn in order to prevent said polymer particles from falling back into said free side space along said helical turn, forcing all of said polymer particles to fall back into said free central space between said helical turn and said removal device.

67. The fluidized bed of claim 60 characterized by a hollow shape of at least part of said helical turns which are connected to said side wall of said reactor by tubes for feeding them with a reactive fluid or coolant and which comprise injection devices.

68. The fluidized bed of claim 60 wherein that at least part of said removal device comprises a succession of flared nozzles, fitting into one another and separated from one another by fins or deflectors which guide said reactive fluids rotating in said reactor toward at least one of said outlet tubes.

69. The fluidized bed of claim 60 wherein that at least part of said removal device comprises a cylindrical or conical nozzle perforated with numerous openings equipped with fins or deflectors which guide said reactive fluids rotating in said reactor toward at least one of said outlet tubes.

70. The fluidized bed of claim 60 where in that at least part of said removal device comprises at least one helical tape wound on itself and wherein the successive turns are separated from one another by fins or deflectors which guide said reactive fluids rotating in said reactor toward at least one of said outlet tubes.

71. The fluidized bed of claim 60 wherein the dimensions of said helical turns vary from one turn to another for at least a portion of said helical turns along said reactor.
